(19) United States
(12) Patent Application Publication
(10) Pub. No.: US 2017/0359613 A1
(43) Pub. Date: Dec. 14, 2017

(54) MEDIA CONTENT RECEPTION AND PLAYBACK CONTROL

(71) Applicant: NAGRAVISION S.A., Cheseaux-sur-Lausanne (CH)

(72) Inventors: SABER HEDHLI, La Ciotat (FR); Marc BELLOCCHIO, Aubagne (FR)

(73) Assignee: NAGRAVISION S.A., Cheseaux-sur-Lausanne (CH)

(21) Appl. No.: 15/538,410

(22) PCT Filed: Nov. 6, 2015
(86) PCT No.: PCT/EP2015/075956

§ 371 Date: Jun. 21, 2017

(30) Foreign Application Priority Data
Nov. 6, 2014 (EP) 14192135.3
May 13, 2015 (EP) 15167587.3

(51) Int. Cl. H04N 21/433; H04N 21/436; H04N 21/41; H04N 21/4367; G06Q 30/06

(52) U.S. Cl. CPC H04N 21/4333; H04N 21/41; H04N 21/4367; H04N 21/43615; H04N 21/4104; G06Q 30/06

(57) ABSTRACT

A receiving device and a method for controlling playback of a media content stream, the receiving device comprising a media player and being associated with a conditional access module is configured to receive, process and play back the media content stream. The receiving device comprises a service selection module configured to receive a user command during playback of a current media content stream and to forward the user command to a media content stream input selector included in the conditional access module. The media content stream input selector is configured to stop reception of the current media content stream and to switch to an input receiving an additional media content stream at reception of the user command, the additional content media stream containing at least one chunk to be injected into the current media content stream, said at least one chunk being configured to pause playback of the current media stream at a time point following reception of the user command.

### FIELD OF THE INVENTION

The present invention generally relates to the domain of the reception and playback of media content either broadcast or on demand. In particular, a receiving device associated with a conditional access module and a method for controlling playback of media content is disclosed.

### TECHNICAL BACKGROUND

Television sets, set-top boxes, personal computers, tablet computers, and the like are known devices on which media content can be received and, in some cases, played back or otherwise presented. In the domain of Over-The-Top (OTT) content delivery, audio, video, and other media content may be delivered to a media receiver over, e.g., the Internet.

The state of the art includes a system comprising a television set for receiving broadcast content, the television set having an OTT device connected thereto, the OTT device may be configured to receive video-on-demand (VOD) assets from the cloud (Internet for example), possibly using wireless means, and to inject a transport stream comprising the VOD asset into the television set for display. A viewer using such a system to view a selected VOD asset from the cloud may decide to stop or pause the playback of the VOD asset at some point during his viewing of the asset. This creates a problem in that it is not easy to avoid time-lag or jitter effects being seen by the viewer either when the pause command is issued or when the resume command to continue with the playback is issued (or both).

This situation is different from known situations in the domain of internet television where advertising content is introduced as pre-roll, mid-roll or post-roll advertising units for display before, during or after a VOD asset, respectively, in that the pause described above is not part of the original VOD asset and so does not appear in the transport stream TS being injected; it is the viewer who decides to create a pause.

### SUMMARY OF THE INVENTION

There is disclosed an OTT-compatible device which is configured to be connected to a media-playing/receiver device such as a television set, for example, and to inject transport stream packets (TS packets) on a TV channel identified by a triplet. A “triplet” is a term which is used in the broadcast industry to mean a set of three identifiers which uniquely identify a service (or channel) in the digital video broadcasting (DVB) suite of industry-accepted standards for digital television, a DVB triplet uniquely identifies a DVB-based service (or channel). A DVB triplet comprises an original network identifier (ONID), a transport stream identifier (TSID) and a service identifier (SID).

According to a first aspect, provision is made for a multimedia reception assembly, comprising a reception module and a peripheral module, the assembly being configured to control playback of a media content according to claim 1. Playback may be achieved on a media player connectable to the reception module. The peripheral module, in accordance with claim 4, is preferably detachably connectable to the reception module via a bidirectional interface. The peripheral module is preferably an OTT device in the sense that it is configured to receive video-on-demand assets from a VOD server, preferably via wireless means. The VOD server may be any remote server, accessible via Internet for example.

A further object of the invention is to provide a method for controlling playback of media content according to claim 12.

A transport stream pause (TS pause) is known in the VOD domain and is recognisable by media players and/or reception modules as meaning that the playback of a content comprising the TS pause should be paused.

The multimedia reception assemblies and the methods of the invention allow for a transport stream pause (TS pause) to be injected into a transport stream which is being viewed when a viewer issues a pause command to his reception module (or media player connected to the reception module), the transport stream being received OTT techniques via a peripheral module communicably connected to the reception module. Playback of the content is paused when the receiver or the media player encounters the TS pause. OTT reception of the content may also stop or the received content may be buffered when the TS pause is encountered. Furthermore, when the viewer issues a command to resume viewing, playback of the content starts from the frame where it was paused, without having to reload a whole chunk of the content and without any time lag or jitter being experienced by the viewer.

### BRIEF DESCRIPTION OF THE DRAWINGS

The present invention will be better understood thanks to the detailed description, which follows, and the accompanying drawing, which is given as non-limiting examples of an embodiment of the invention, namely:

FIG. 1, showing a reception module associated with a conditional access module, the reception module has access to a media player configured for playing media content provided by a broadcaster or by a media server.

### DETAILED DESCRIPTION OF THE INVENTION

In the domain of Over-The-Top content delivery (OTT), audio, video, and other media content may be delivered over the Internet. An OTT-compatible device, such as a conditional access module (CAM), is configured to be connected to a reception module REC or a set-top-box comprising a media player MP such as a television set and to inject transport stream packets (TS packets) or a chunk onto a particular television channel as identified by a DVB triplet. The conditional access module or other suitable peripheral module is preferably configured to be detachable from the reception module.

Examples of reception modules according to embodiments of the present invention include but are not limited to: a set-top-box; a television set; or a personal computer. A system in which an embodiment of the present invention may be deployed includes a reception module and a peripheral module such as a conditional access module, preferably removably connectable to the reception module. Conditional access modules may be in the form of a PCMCIA (Personal Computer Memory Card International Association) module, connectable via a “common interface” or a dongle connectable to a universal serial bus interface. The reception module is configured to receive broadcast content stream for example via satellite transmission, terrestrial broadcast transmission, cable transmission, or via a wired or wireless network performing streaming using for example IP (Internet Protocol) multicast or unicast techniques. This reception is usually a unidirectional reception. The reception module is configured to send the broadcast content stream to the conditional access module (peripheral module) via the interface between the two modules in order to allow the conditional access module to process the broadcast content (for example to perform decryption). The conditional access module is also configured to receive media content stream, usually by wireless means and preferably in bi-directional fashion via a separate VOD input, thereby allowing for VOD content to be received by the reception module. The conditional access module is configured to receive a command, via the interface between the two modules, instructing the CAM to switch to process either the broadcast content or the VOD content, depending on which channel a user selects to view (the selection may correspond to a part of the broadcast content or the VOD content). Embodiments of a multimedia reception assembly of the present invention therefore allow for a user to select whether he wants: to view broadcast content received via a first channel or input by the reception module and sent via an interface to the conditional access module for processing before being returned to the reception module via the interface between the two modules; or to view VOD content received via a second channel (or input) by the conditional access module and processed by the conditional access module then sent to the reception module via the interface. The reception module comprises a service selection module to receive a user command, usually via a remote control, to switch to a chosen service, which may come from the broadcast side or the VOD side. The reception module sends a signal via the interface to the conditional access module causing the conditional access module to switch to processing of the broadcast content arriving via the interface or to switch to processing the VOD content which is injected via the second input, this depending on whether the chosen service is a broadcast service or a VOD service.

The broadcast content is usually received by the conditional access module from the reception module as a multiple program transport stream (MPTS) comprising a plurality of services in a plurality of programs. However, depending on which service is selected, the processing performed by the conditional access module is performed on a single program transport stream (SPTS) which the conditional access module filters from the multiple program transport stream. It is said that the VOD content received by the conditional access module is injected. By this it means that an injection module in the conditional access module injects the content into the multiple program transport stream thereby forming a new programme within the MPTS which is describable and selectable using descriptors, e.g. a DVB triplet, in the same way that a particular broadcast content can be selected from the MPTS. The VOD content can therefore be said to be injected into a particular TV channel identifiable by a DVB triplet. The filter or switch (input selector) in the conditional access module is therefore able to filter the required content depending on the command received from the reception module indicating which service was chosen.

Methods and apparatus disclosed in the herein may involve the use of DVB tables, such as program map tables (PMT), included in Program Specific Information (PSI) as known in the broadcast domain. As such, one or more DVB tables may be included as PSI within broadcast content. DVB tables also exist in the video-on-demand domain in the sense that one or more DVB tables may be included as PSI within VOD program content. Methods and apparatus described herein may also involve the use or manipulation of TS packets which have been injected into a received content by an OTT-compatible device having received the TS packets as part of a VOD content (OTT content).

The Program Specific Information (PSI) is defined notably by the standard ISO/IEC 13818-1 MPEG-2 “Information technology—Generic coding of moving pictures and associated audio information: Systems”. The Program Specific Information data, allowing for a receiver (c.f. reception module) to be configured in an automatic way for de-multiplexing and decoding the different program streams, is structured in tables, such as: the Program Association Table (PAT) indicating for each service of a multiplex, the localization i.e. the values of Packet Identifiers (PID) of packets of the transport stream (TS) of the corresponding Program Map table (PMT), which identifies and indicates the localizations of the streams of each service and the localization of the Program Clock Reference (PCR) fields for a service. The Program Specific Information (PSI) further comprises data allowing a viewer to identify services and events transported in a multiplex or in a network. This data is distributed in tables such as the Service Description Table (SDT) containing data describing services such as the names and the providers of the services.

The present disclosure refers to chunks of content as known in the adaptive streaming domain, where a chunk of content may comprise a number of packets of audio/video content from an audio/video asset for example, along with PSI such as DVB tables useful for rendering a given duration of the audio/video asset at a given resolution.

In embodiments which include a media player. when the media player starts playback of a content, it first stores one or more chunks of the content into a buffer of the media player and begins playback of the stored chunks while the next chunks are being downloaded from the network (VOD or broadcast) and processed by the conditional access module and/or the reception module REC having access to the media player. When the reception module itself performs the media playing function, such buffering may take place in a memory of the reception module or in an external memory to which the reception module has access. Optionally, the peripheral module (CAM) may perform the buffering function in a memory of the peripheral device when the content is VOD or OTT content.

According to an embodiment, a viewer using a reception module REC of the invention to receive and view a selected VOD asset from the cloud or from a server on a network via a peripheral module communicably connected to the reception module, may decide to pause the playback of the VOD asset at some time point during viewing of the asset. In such a case, a transport stream pause (TS pause) will be injected into the transport stream being received by the receiver module via the peripheral module according to any of the methods described below. The injection is made, by the peripheral module, into the MPTS received from the reception module and results in a new MPTS being created, with the transport stream pause appearing in the same channel into which the VOD content was being injected. This results in a pause in the VOD content when the corresponding SPTS gets back to the reception module's decoder.

The transport stream pause described herein has a number of technical characteristics which produce the effect that the transport stream pause may be downloaded from the cloud or server in the same way as the VOD asset, or it may be generated in the peripheral module. As such, the transport stream pause should have a chunk size which is the same as the chunk size of the VOD asset in that the chunks have the same number of transport stream packets. Preferably, the same codec, or at least a codec of the same type, that is used for coding or decoding content received from the broadcast channel by the reception device should be able to properly interpret the transport stream pause. The transport stream pause preferably comprises a service description table (SDT), a program allocation table (PAT) and a program map table (PMT) as well as at least one video PID and/or one audio PID (program ID as known in broadcast domain). A program clock reference (PCR) should also be present, preferably on the video PID. Finally, the transport stream pause should preferably represent a closed group of pictures (GOP) starting with an I-frame.

Conditions for a transport stream pause according to embodiments of the invention may be summarised as being at least:

a) the size of a chunk within the transport stream pause equals the chunk size within the current VOD asset;

b) the codec (compression/decompression program, hardware or middleware) used for the transport stream pause is the same as the one used on the current television channel or at least the same type;

c) The SDT (Service Description Table), PAT (Program Allocation table) and PMT (Program Map Table) have to be available;

d) The audio and the video content packets have each a given PID (Packet Identifier);

e) The video PID includes or is otherwise associated with a Program Clock Reference (PCR); and

f) The chunk forms a closed Group of Pictures (GOP), starting with an I-frame defined as an “Intra-coded picture”, i.e. a fully specified picture, like a conventional static image file.

The Program Clock Reference (PCR) is used to define a time point PT in the rendered VOD. Depending on used technology, the time point TP may be expressed in hours, minutes, and seconds or by a number of video frames from the start or from a predefined reference in the content.

According to an embodiment, a user (viewer) who is viewing a selected VOD content, received by the peripheral device from a VOD server, wants to pause the playback of the VOD content and so issues a pause command by pressing an appropriate button on a remote controller at an arbitrary time point during the playback. The reception module receives the command and sends a corresponding instruction or signal, via the interface, to the peripheral device. Consequently, the peripheral device injects a transport stream pause (as described above) into the MPTS. The transport stream pause has a size of at least one chunk. The thus-injected transport stream pause makes its way back to the reception module via the interface, just as the VOD content did. If playback is being performed by a media player, the media player pauses when it receives the transport stream pause, otherwise if the reception module performs the playback, the reception module pauses when the transport stream pause is received. The pause may be described as a virtual pause since it does not force the player to activate a built-in pause function. Instead it creates the same effect as such a built-in pause in the sense that the viewer will see a blank screen or a black or white or otherwise “neutral” screen depending on the value of the payload of the transport stream pause chunks. According to one embodiment the transport stream pause payload represents a black screen. The viewer will then see a black screen for the duration of the pause as long as transport stream pause chunks are being injected by the peripheral module. A transport stream pause chunk can therefore be said to comprise blank content, used to simulate a pause. The pause occurs after a time period corresponding to the processing time of the user command CMD by the reception module REC and the time to receive the instruction in the peripheral device, inject the transport stream pause and process the injected content and transport stream pause. By arranging for the injection of the transport stream pause to be done in the manner described below, a viewer will not experience a time lag or jitter related to the pause.

As is known, a transport stream packet has a header and a payload and may have an adaptation field. The adaptation field has a PCR flag which can be set if a PCR field is included. The header has a Payload Unit Start Indicator bit, which is a Boolean flag allowing for the start of an elementary stream or the start of some Program Specific Information (PSI) to be identified. The adaptation field also has a discontinuity indicator, which is used to indicate that the current packet is in a discontinuity state with respect to the PCR.

When the peripheral module receives the instruction to pause, it waits until it detects a transport stream packet in the VOD content which includes a program clock reference (PCR) and stops the injection of the VOD content at that point. The peripheral module also sets the discontinuity indicator of the packet where the PCR was found, to one. The injection is stopped at the packet with the PCR was found, in the sense that the packet with the PCR and any subsequent packets are not sent for processing. Instead they are held back (in a buffer or by instructing the VOD server to stop sending content). The peripheral module is therefore configured to detect the PCR flag, stop the injection of the VOD content at that packet in the transport stream and set its discontinuity indicator to one. Next, the peripheral module injects the transport stream pause, the first packet of the transport stream pause being injected at the position where the VOD content packet would have been injected. Before injecting this packet (pause), the peripheral module sets the Payload Unit Start Indicator to one. The reception module will know that a new elementary stream is being received, the elementary stream being the transport stream pause which the peripheral device has injected. Finally, when a resume command is received (by a user issuing the command to the reception module and the reception module sending a corresponding signal to the peripheral module via the interface), the peripheral module stops injecting transport stream pause chunks (chunks of blank content) and restarts injection of the VOD content, starting from the VOD content which was found to have a PCR value and in which the discontinuity indicator was set. The discontinuity indicator is in the adaptation field and is used to indicate that the current packet is in a discontinuity state with respect to the PCR. In this way a discontinuity is marked where the transport stream pause has been injected. In this manner, when the reception device receives the VOD packet which has a “strange” PCR value it will not create a jitter because the reception device has been warned that there should be a discontinuity.

According to different embodiments, the transport stream pause (or blank content chunks) can either be downloaded from a server (VOD server) or generated in the peripheral module or even received from the reception module via the bidirectional interface; according to some embodiments the blank content chunks may be prestored in the peripheral module or in the reception module instead of being generated.

According to different embodiments, the transport stream pause chunks could be configured to cause a black, patterned or colored screen to be displayed, or a static image, a video sequence loop, etc. . . . and may further include a message indicating how to resume the pause. The transport stream pause chunks may therefore be conveniently referred to as comprising blank content or neutral content or even pause content, which replaces the VOD content for the duration of the requested pause.

When the user wants to resume playback of the VOD content, he or she may issue a further command on the remote control for the attention of the reception module (or the media player), the service selector S SEL forwards the command to the input selector IN SEL of the peripheral module via the interface. The peripheral module then stops the injection of the transport stream pause and restarts the injection of the VOD content from the packet having the PCR, which was held back, and where the discontinuity indicator was set. The reception device (or media player) then expects the discontinuity in the PCR value and so jitter is created.

According to an embodiment, the user command which is issued to indicate a pause, may include a parameter defining a pause duration. This duration may be set by the remote control or preset in a configuration file stored in a memory of the reception module REC. For example, the user may press the “pause/resume” button followed by numeric button “300” to set a pause parameter of 5 minutes. At the end of the duration defined by the parameter, the pause is resumed automatically by using the same mechanism as when a resume command has been received by the service selector S SEL.

According to a further embodiment, a maximum pause duration may be set in the configuration file in order to prevent useless stream processing and playback in absence of the viewer. At the end of the maximum duration, the reception module REC may stop stream processing and enter into a stand by mode requiring intervention of the user to restart playback of the current media content or to select a new media content to playback.

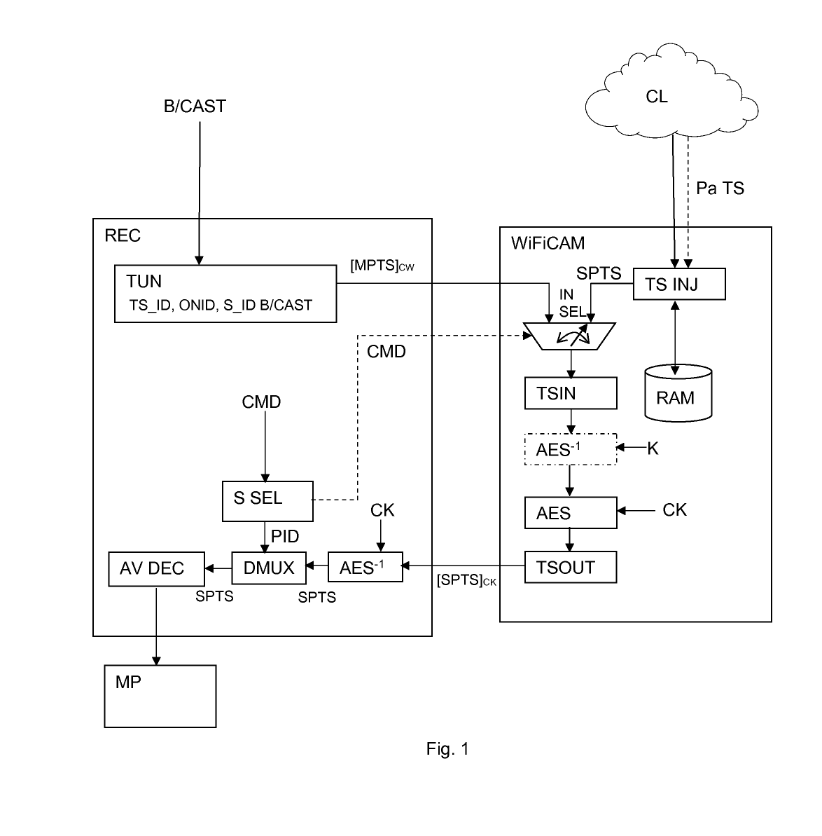

The method may be performed in a reception module REC, as shown by FIG. 1, comprising a tuner TUN for receiving media content from a broadcaster B/CAST of barker channels for example. Barker channels are television channels dedicated to list or promote media content on other channels i.e. available VOD schedule and/or program descriptions and trailers.

The broadcast channels may be identified by a DVB triplet comprising a transport stream identifier TS_ID, original network identifier ONID, and a service identifier S_ID). The reception module REC is associated with an OTT (Over-The-Top) device configured to receive content from a further source such as Internet or cloud and may comprise a storage device for storing received content.

According to a preferred implementation, the OTT device may consist of a conditional access module (CAM) having a WiFi connection interface able to establish a wireless connection to Internet. The OTT device, hereafter called WiFiCAM, may be preferably configured to connect to the reception module REC via an appropriate interface such as a common interface port of type CI or DVB-CI as defined in EN 50221 standards by CENELEC, the European Committee for Electrotechnical Standardization. Alternatively, the conditional access module (CAM) may be connected to the reception module REC via a Universal Serial Bus (USB).

According to an embodiment, the common interface CI is configured to send a multi-programme transport stream MPTS comprising content received by the tuner TUN of the reception module REC to the WiFiCAM and a single programme transport stream SPTS from the WiFiCAM back to the reception module REC. Generally the multi-programme transport stream [MPTS]_{CW} comprises content encrypted with control words CW extracted from ECM control messages, as known in the domain of Pay-TV.

According to an embodiment, the WiFiCAM may comprise decryption capability allowing for decryption of the encrypted content to be performed and it may further include capability for encrypting such that the single programme transport stream SPTS sent back to the reception module REC may also be encrypted with a local key CK ([SPTS)_{CK}) by using an AES (Advanced Encryption Standard) algorithm for example or any other suitable algorithm using symmetric keys.

In the case where provision is made for the reception of an encrypted VOD asset, the WiFiCAM may decrypt the VOD asset with an appropriate key K using for example an AES decryptor, noted AES⁻¹ in FIG. 1. The WiFiCAM may encrypt the VOD asset with the local key CK before sending the corresponding transport stream ([SPTS)_{CK}) to the device REC which decrypts the incoming transport stream from the WiFiCAM to obtain a decrypted transport stream SPTS. This decrypted transport stream SPTS is then forwarded to the media player MP associated with the reception module REC.

The service selector S SEL of the reception module REC allows for the selection of a channel to view either a broadcast channel to which the tuner TUN is connected or the channel provided by the WiFiCAM, which is connected to the cloud via Internet according to a preferred embodiment. The service selection is based on a service identifier S_ID allowing for a broadcast channel to be distinguished from a VOD channel provided by the WiFiCAM and on packet identifiers included in the transport stream TS. According to embodiments of the invention, the service selector S SEL may also allow for selection, upon reception of an appropriate user command, of a VOD content stream having had a transport stream pause comprising chunks adapted to the currently viewed media content inserted into the VOD content stream.

According to different embodiments, when the peripheral module receives a signal to pause playback of the VOD content, the VOD content coming in from the VOD server may be buffered in the peripheral module for the duration of the pause or until a resume command is received, the VOD content then being read out from the buffer when playback is to be resumed, in a FIFO fashion. Alternatively, the peripheral module may instruct the VOD server to stop sending further VOD content until the pause duration has elapsed or until a resume command is received. A mixture of both these methods is also possible according to some embodiments.

1. A multimedia reception assembly comprising:
a receiver for receiving media content, the receiver having access to a media player and being configured to allow a user to enter a pause request to pause playback of a currently viewed media content; and
a peripheral module for receiving video-on-demand (VOD) media content from a VOD server, the peripheral module being removably connectable to the receiver via a bidirectional interface, the peripheral module being configured to:
process at least the VOD media content and send at least the processed VOD media content to the receiver via the bidirectional interface;
receive a pause instruction from the receiver via the bidirectional interface at least while the processed VOD media content is being received;
stop the sending of the processed VOD media content at a transport stream packet comprising a Program Clock Reference (PCR) value, following reception of the pause instruction;
send at least one chunk of blank content via the bidirectional interface to the receiver beginning where the sending of the processed VOD media content stopped, following reception of the pause instruction; and
set a discontinuity indicator in a part of the packet comprising the PCR value and set a payload unit start indicator in a part of the packet of the chunk of blank content.

2. The multimedia reception assembly according to claim 1, wherein the pause instruction has a given duration, and wherein the peripheral module is configured to continue sending further chunks of blank content for the duration of the pause instruction.

3. The multimedia reception assembly according to claim 1, wherein the receiver is further configured to send a resume instruction to the peripheral module via the bidirectional interface at least while the at least one chunk of blank content is being received and the peripheral module is further configured to stop sending chunks of blank content and to resume sending of the VOD media content starting at the VOD transport packet comprising the PCR value and in which the discontinuity indicator was set.

4. A peripheral module having a video-on-demand (VOD) media content input and a bidirectional interface, comprising:
a buffer for storing at least part of a received VOD media content; and
a processor for processing at least the VOD media content;
wherein the peripheral module configured to:
receive a plurality of packets of VOD media content via the VOD media content input;
send the at least one of the processed VOD media content packets via the bidirectional interface;
receive a pause instruction via the bidirectional interface;
stop the sending of the processed VOD media content at a transport stream packet comprising a Program Clock Reference (PCR) value, following reception of the pause instruction;
send at least one chunk of blank content via the bidirectional interface beginning where the sending of the processed VOD media content stopped, following reception of the pause instruction; and
set a discontinuity indicator in a part of the packet comprising the PCR value and set a payload unit start indicator in a part of the packet of the chunk of blank content.

5. The peripheral module according to claim 4, wherein the VOD media content input is a wireless input.

6. The peripheral module according to claim 4, wherein the bidirectional interface is a Common Interface, the peripheral module being a conditional access module, the VOD media content being encrypted and the processing performed by the processor including a step of decryption.

7. The peripheral module according to claim 4, wherein the VOD media content is adapted for receiving streaming content.

8. The peripheral module according to claim 4, wherein the pause instruction has a given duration and chunks of blank content are sent for the duration of the pause instruction.

9. The peripheral module according to claim 4, further configured to:
receive a resume instruction via the bidirectional interface; and
stop sending chunks of blank content and to resume sending of the VOD media content starting at the VOD transport packet comprising the PCR value and in which the discontinuity indicator was set.

10. The peripheral module according to claim 4, further configured to generate the chunks of blank content, said chunks comprising transport stream packets having payloads arranged to display an image which may be considered to be a blank screen to replace the VOD media content.

11. The peripheral module according to claim 4, further configured to receive said chunks of blank content from a server via the VOD media content input or from a receiver via the bidirectional interface.

12. A method for pausing playback of a video-on-demand (VOD) media content using a media reception assembly comprising a receiver having access to a media player and a peripheral module for receiving the VOD media content via a VOD input, the receiver and the peripheral module being communicably connected via a bidirectional interface, comprising:
receiving the VOD media content in the peripheral module via the VOD input;
processing the VOD media content in the peripheral module;
sending at least one packet of the processed VOD media content to the receiver via the bidirectional interface;
receiving, by the peripheral module, via the bidirectional interface, an instruction to pause playback of the VOD media content;
stopping sending of the VOD media content when a packet of the VOD media content comprising a Program Clock Reference (PCR) value is found and setting a mark discontinuity indicator in a part of said packet of the VOD media content; and
setting a payload unit start indicator in a part of a first packet of a chunk of blank content and sending the chunk via the bidirectional interface in place of the VOD media content.

13. The method for pausing playback according to claim 12, wherein the pause instruction further comprises a pause duration, further comprising:
continuing to send further chunks of blank content for a period corresponding to the pause duration, then stopping the sending of chunks of blank content; and
sending the VOD media content after the pause duration has elapsed, starting from the VOD media content packet having the PCR value and having the discontinuity indicator set.

14. The method according to claim 12, further comprising:
receiving a resume instruction via the bidirectional interface,
stopping the sending of chunks of blank content; and
sending the VOD media content after the pause duration has elapsed, starting from the VOD media content packet having the PCR value and having the discontinuity indicator set.
